(19) United States
(12) Patent Application Publication
(10) Pub. No.: US 2020/0137662 A1
(43) Pub. Date: Apr. 30, 2020

(54) METHOD AND DEVICE FOR THE WIRELESS TRANSMISSION OF DATA IN NETWORKS

(71) Applicant: COMMISSARIAT A L'ENERGIE ATOMIQUE ET AUX ENERGIES ALTERNATIVES, PARIS (FR)

(72) Inventors: Mounir KELLIL, Massy-Palaiseau (FR); Pierre ROUX, Jouy-en-Josas (FR); Christophe JANNETEAU, Chaudon (FR)

(21) Appl. No.: 16/664,656

(22) Filed: Oct. 25, 2019

(30) Foreign Application Priority Data
Oct. 29, 2018 (FR) 1859994

(51) Int. Cl. H04W 40/32; H04W 24/08; H04L 12/26; H04B 11/00

(52) U.S. Cl. CPC H04W 40/32; H04W 24/08; H04W 84/18; H04L 43/12; H04B 11/00; H04L 43/10

(57) ABSTRACT

A method implemented by computer to transmit data blocks formed by several data fragments, in a wireless network includes a plurality of nodes, the network having at least one routing path defined between a source node and a destination node and composed of a plurality of nodes such that three nodes at positions n/n+1/n+2 on the routing path define a child/parent/grandparent triad, the method comprising at least the following steps carried out on a triad of child, parent and grandparent nodes: sending from a child node a child/parent probing message, referred to as a “ping” message, to a parent node; sending from the parent node having received the “ping” message a parent/grandparent probing message, referred to as a “yin” message, to a grandparent node, if the parent node is available in a wait state; sending from the grandparent node having received the “yin” message a parent/grandparent probing response message, referred to as a “yang” message, to the parent node, if the grandparent node is available; sending from the parent node having received the “yang” message a child/parent probing response message, referred to as a “pong” message, to the child node, if the parent node is still available; and upon reception of the “pong” message by the child node, transmitting a data fragment from the child node to the parent node.

### CROSS-REFERENCE TO RELATED APPLICATIONS

This application claims priority to foreign French patent application No. FR 1859994, filed on Oct. 29, 2018, the disclosure of which is incorporated by reference in its entirety.

### FIELD OF THE INVENTION

The invention is in the field of wireless communications, and more particularly concerns a method and a device for transmitting data in wireless mesh networks.

### BACKGROUND

In wireless communication networks, the transmission of a data file (102) from a source node ‘S’ to a destination node ‘D’ generally takes place via a set of relay nodes ‘Ni’ which forms a multi-hop wireless communication path, such as the one illustrated schematically in FIG. 1. The intermediate nodes ‘Ni’ are wireless communication relays which cannot transmit and receive simultaneously. This communication mode is commonly called “half-duplex” mode. Wireless technology can exploit for example electromagnetic radio waves, or according to another example, underwater acoustic waves. In these environments, the communication rate from a node to its neighbour is limited and communication latency is not negligible, in particular in the case of acoustic communication. Moreover, the distance between the intermediate nodes is generally assumed to be close to the maximum distance (in terms of radio range) offered by the wireless technology used. It follows that direct communication over two hops is typically impossible; a receiving node is assumed to detect only the signals transmitted by its two immediately neighbouring nodes.

Also, a first challenge is to transmit a file as fast as possible from a transmitting node to the destination node through a multi-hop network.

A simple approach involves transmitting the data file (102) from the source node ‘S’ over the first hop (a misuse of language to denote the transmission to the first intermediate node ‘N1’), then over the second hop, etc., until the target node (D) is reached, as illustrated in FIG. 2, in the example of DTN networks (V. Cerf. et al., “Delay-Tolerant Networking Architecture”, RFC 4838, April 2007). The drawback of this approach is that it underutilises the parallel transmission capacities for file fragments over several hops.

Another approach, referred to as multi-fragment, involves fragmenting the complete file, then successively transmitting the file fragments (i.e. data packets) without waiting for a fragment “Fn” to arrive at the destination before transmitting a fragment “Fn+1”. FIG. 3 illustrates such a multi-fragment multi-hop sequencing (three fragments in the case illustrated). This approach is more effective than the transmission of the complete file, since it exploits parallelism to accelerate the transmission. In the case illustrated, it is possible to use up to three hops in parallel. The greater the number of hops, the higher the gain, since on the one hand (the approach in FIG. 2) there is the simultaneous use of only one communication link, and on the other hand (the approach in FIG. 3) there is a simultaneous use of possibly up to a third of the communication links. The limit however is that it is not possible to exceed the usage rate of one hop in three. When transmission is taking place over a hop ‘n’, it is not possible to have transmissions taking place over hops ‘n+1’ and ‘n+2’. In other words, at a given moment there can be at most one hop out of three which is used to transmit a fragment. This is understood by considering that two successive hops cannot be simultaneously active in transmission since one node should then both transmit and receive, and by also considering that in the case of active transmissions over hops ‘n’ and ‘n+2’, there would be one node which receives signals coming from its two immediate neighbours and which could then decode neither one nor the other since each one is an interference for the other. This leads to the occurrence of a “collision”.

To overcome these drawbacks and produce an optimal approach (i.e. parallelisation of multi-hop transmission), one solution involves sequencing in time the fragments transmitted by the first node. Once a fragment “Fn” is transmitted by this node, the latter is placed in a wait state for the time necessary for the fragment Fn to have been received and sent by the next two nodes on the path to the recipient; then the fragment Fn+1 is transmitted once this wait time has expired. If the transmission times can be reproduced, this simple sequencing can be sufficient to ensure optimal behaviour.

However, this solution is not satisfactory since it requires fixing an arbitrary pause time (i.e. wait state) and it does not provide for adapting to the diversity of transmission conditions that can be observed in practice. Specifically, hops do not often have the same distance, they do not endure the same levels of interference, etc. Also to overcome these difficulties, it is possible to increase the pause time. By taking a pause time corresponding to the time required for a fragment to propagate over three hops when the transmission conditions are good (i.e. the hops are not at the limit and interference levels are low) and by multiplying this time by two, or even by three, it is probable that any risk of collision in the multi-hop multi-fragment transmission is avoided. However the performance levels of such a system are very suboptimal since the end-to-end file transmission speed will be much lower than it could be.

Moreover and more generally, the issues that come up in the context of linear networks exist in the context of mesh networks. FIG. 4 schematically illustrates a mesh network context in which in general a gateway node ensures the passage between the mesh network and the Internet. This gateway node is hence the destination ‘ID’ (or, respectively, the source ‘S’) of all the data transmitted (or, respectively, received) by the nodes ‘Ni’ of the mesh network. Once a routing path is established between a node of the mesh network and the gateway node, the issue is then to know how to sequence the transmission of file fragments over this path so as to transmit a volume of data as fast as possible from the source node to the gateway node.

Mesh networks are generally formed by nodes which do not have the capability of transmitting and receiving at the same time. When a node has to transmit a data packet to one of its neighbours, there is a risk that this packet is not received if a collision has taken place due to the simultaneous transmission of another packet by a neighbouring node which has disturbed the receiving node. This phenomenon can be reduced by applying a function for listening to the channel before transmission: a node which must transmit a packet will listen to the transmission channel to ensure that it is silent, and then it will switch to transmission mode and transmit the packet.

However, this principle can merely reduce and not avoid the risk of collision, and this is for two major reasons:
The detection of an absence of a transmitted signal (channel silence) remains a relative notion: the transmitting node can consider that the channel is silent while the channel is in fact not silent from the point of view of the receiving node which can perceive signals transmitted by its own neighbours, which can be undetectable to the transmitting node; and
Channel silence before a packet is transmitted does not indicate channel exclusivity over this transmission. Two neighbouring nodes having to transmit can detect the channel silence simultaneously and switch to transmission mode simultaneously also, thereby causing simultaneous transmissions and therefore risks of collisions.

To overcome this difficulty, extensions to the CSMA-CA (Carrier Sense Multiple Access with Collision Avoidance) principle make provision for acknowledgement messages for the packet received by the receiver. The packet can then be repeated until an acknowledgement is received, such that the transmission is in the end effective even if there are collisions. Random retransmission counters are then introduced to avoid the risk of collisions “upon repetition”. The CSMA-CA principle is defined for example by The IEEE (The Institute of Electrical and Electronics Engineers) in the Wi-Fi standards IEEE 802.11.

A variant of the CSMA-CA principle can entail the installation of reservation mechanisms via RTS (Ready To Send) and CTS (Clear To Send) short messages or signals through which a transmitter reserves a channel for transmitting a longer data packet. The RTS message is transmitted by the node wishing to transmit the packet. It contains the estimated duration of the transmission of the packet. It effectively starts transmitting this packet only when it has received a CTS message from the receiver, confirming the availability of the receiver and the channel silence as observed by this receiver. The CTS message also itself contains the (same) estimated transmission duration for the packet. All the neighbouring nodes of the transmitter or receiver which could detect either the CTS message or the RTS message enter the hold state for the indicated duration. They are supposed to refrain from transmitting during the transmission time of the packet. They must wait for the current transmission to end and always check the availability of the channel before their own transmission. If nodes in a hold state receive RTS signals intended for them, they must wait until they leave the hold state before sending the CTS signal.

Nevertheless, there again, the risk of collision is not averted since it can occur on the RTS and CTS messages themselves. Furthermore, the RTS-CTS mechanism exhibits as a drawback the necessary predictability of the transmission time. Now this transmission time is difficult to predict due to the variability of radio communication conditions. To ensure the transmission of the packet and the absence of collisions, the transmission channel must be reserved for a time much greater than that which will actually be necessary, i.e. the margin is necessarily high, thereby leading to underexploitation of the channel.

Thus, given the various drawbacks noted by the use of existing techniques, there is a need to address these drawbacks and propose a “self-adapting” system which itself discovers the optimal rate with which to transmit the fragments of a data file over a wireless communication path. The present invention fulfils this need.

### SUMMARY OF THE INVENTION

An object of the present invention relates to a data transmission method in a wireless network providing for automatically adapting the data packet transmission rate to the transmission time for the packets.

Advantageously, the invention provides for an optimum rate for the data fragments to be transmitted, so as to optimise transmission time. The invention enables simultaneous usage of a maximum number of communication links over a routing path.

The solution claimed is differentiated from a solution of the “regular rate with a fixed pause between fragments” type or “RTS-CTS” type in that it automatically adapts to the transmission time for the packets.

The invention can be advantageously applied to a number of technical fields resorting to linear wireless communication networks or mesh networks. The invention is particularly well suited to the field of monitoring and maintenance of underwater pipeline sites using an autonomous underwater vehicle. Specifically, the claimed method facilitates the installation of a communication infrastructure between an autonomous vehicle and a moored ship, using a mesh network of acoustic modems.

To obtain the results sought, there is proposed a method implemented by computer to transmit data blocks formed by several data fragments, in a wireless network comprising a plurality of nodes, the network having at least one routing path defined between a source node and a destination node and composed of a plurality of nodes such that three nodes at positions n/n+1/n+2 on the routing path define a child/parent/grandparent triad, the method comprising at least the following steps carried out on a triad of child, parent and grandparent nodes:

sending from a child node a child/parent probing message, referred to as a “ping” message, to a parent node;

sending from the parent node having received the “ping” message a parent/grandparent probing message, referred to as a “yin” message, to a grandparent node, if the parent node is available in a wait state;

sending from the said grandparent node having received the “yin” message a parent/grandparent probing response message, referred to as a “yang” message, to the said parent node, if the grandparent node is available;

sending from the said parent node having received the “yang” message a child/parent probing response message, referred to as a “pong” message, to the said child node, if the parent node is still available; and

upon reception of the “pong” message by the child node, transmitting a data fragment from the child node to the said parent node.

According to alternative or combined embodiments:

the steps of the method are repeated for several triads of child/parent/grandparent nodes, on a routing path from a data transmitting source node up to a recipient node for the data.

the triads of child/parent/grandparent nodes are predefined.

the data transmission step consists in successively transmitting data packets.

the method additionally comprises a step for verifying the integrity of the data received.

the “ping”, “yin” probing messages and the “yang”, “pong” probing response messages, are short messages encoded in ASCII.

Another subject of the invention is a device for transmitting, in a wireless network, data blocks formed by several data fragments, the device comprising means for implementing the steps of the claimed method.

According to alternative or combined embodiments:

the wireless network is a mesh network.

the mesh network is a mesh network comprising a plurality of acoustic modems.

one modem is a source node corresponding to an autonomous underwater vehicle and one modem is a gateway node to a ship, the device enabling the transmission of data relating to measurement reports, from the autonomous underwater vehicle to the ship.

each modem is coupled respectively to a modem controller, in particular via an RS232 serial link.

the means for carrying out the steps of the claimed method are a state machine.

The invention also covers a computer program product, the said computer program comprising non-transient code instructions for carrying out the steps of the claimed method, when the said program is executed on a computer.

### DESCRIPTION OF THE DRAWINGS

Different aspects and advantages of the invention will appear in support of the description of a preferred mode of implementation of the invention but not limiting, with reference to the drawings below:

FIG. 1 is a simplified representation of a linear wireless communication network;

FIG. 2 is a simplified representation of a multi-hop communication in a linear wireless communication network;

FIG. 3 is a simplified representation of a multi-fragment multi-hop communication in a linear wireless communication network;

FIG. 4 is a simplified representation of a mesh communication network enabling an implementation of the invention;

FIG. 5 is a simplified representation of the two-hop probing principle implemented in the method of the invention;

FIG. 6 is a simplified representation of a communication infrastructure of a mesh network of acoustic modems for implementing the device of the invention;

FIG. 7 illustrates a message communication sequence for the transmission of file fragments, implementing the probing principles of the invention according to one embodiment; and

FIG. 8 is a simplified representation of a state machine for implementing the method of the invention.

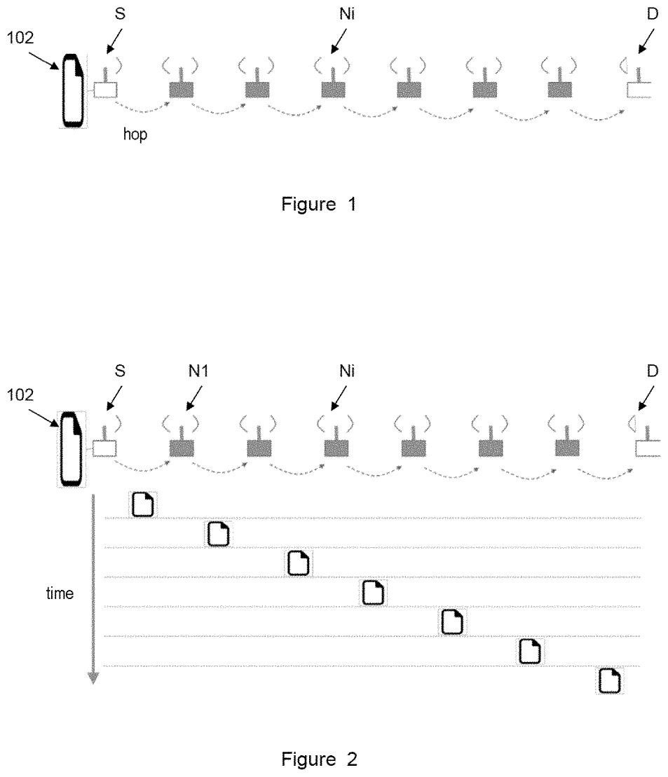

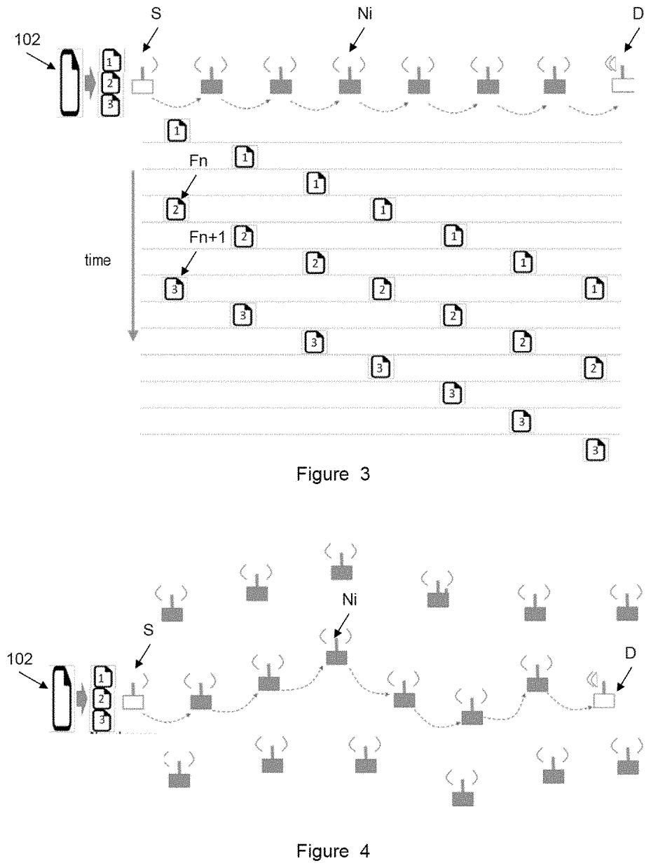

### DETAILED DESCRIPTION

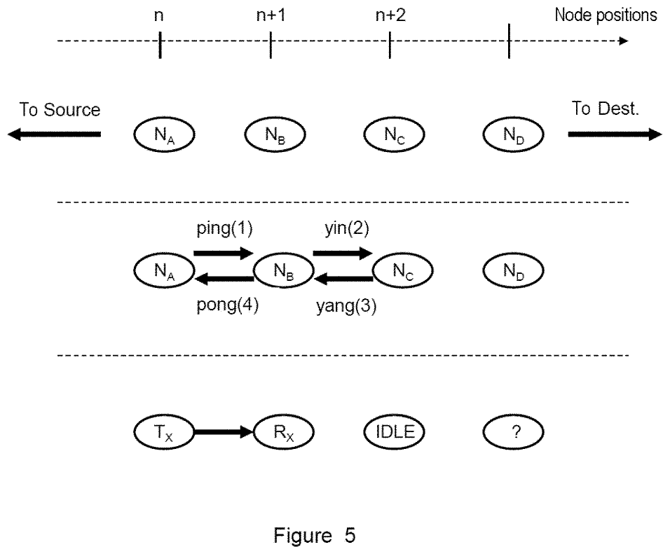

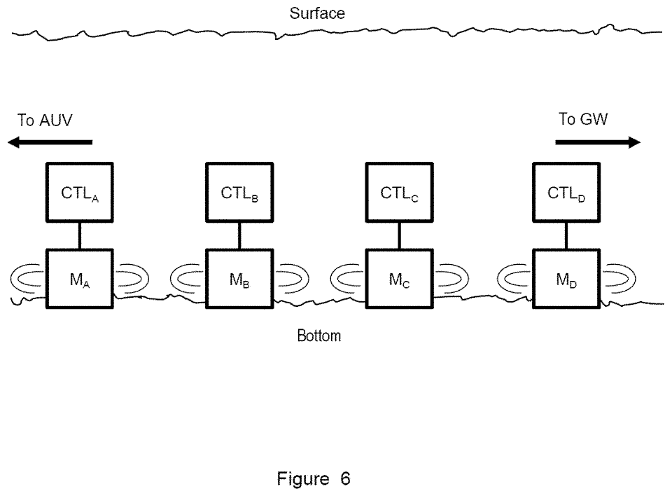

FIG. 5 is a simplified representation of the two-hop probing principle on a triad of nodes, implemented in the method of the invention. For the purposes of the description, four nodes (N_{A}, N_{B}, N_{C}, N_{D}) are illustrated. They can be for example intermediate nodes of a routing path in a mesh network such as the one in FIG. 4, between a source node and a recipient node. In the context of implementing the invention for the maritime field, for example that of the monitoring and maintenance of underwater pipeline sites, the mesh network can be an infrastructure for establishing communications between an autonomous underwater vehicle (or AUV) and a moored ship, the AUV serving as source node (initial transmitter) which has to send data blocks to the moored ship serving as final recipient node to receive the data blocks. The data is transmitted via routing paths defined for the mesh network. The mesh network comprises a plurality of communication nodes between a source node (AUV) and a gateway node (GW), as represented in FIG. 6. Each node is made up of an acoustic underwater modem (M_{A}, M_{B}, M_{C}, M_{D}), and each modem is coupled respectively to a modem controller (CTL_{A}, CTL_{B}, CTL_{C}, CTL_{D}) for example via an RS-232 serial link. A person skilled in the art understands that the description is based on a particular example implementation of the invention, but that this does not at all limit the various implementations in various fields and for any variant embodiment which maintains the two-hop probing principles of the invention.

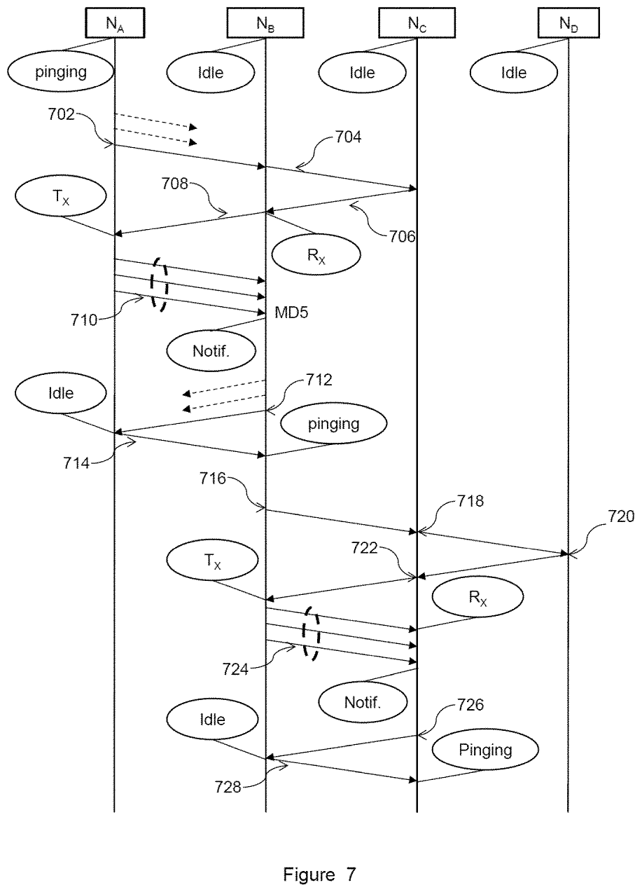

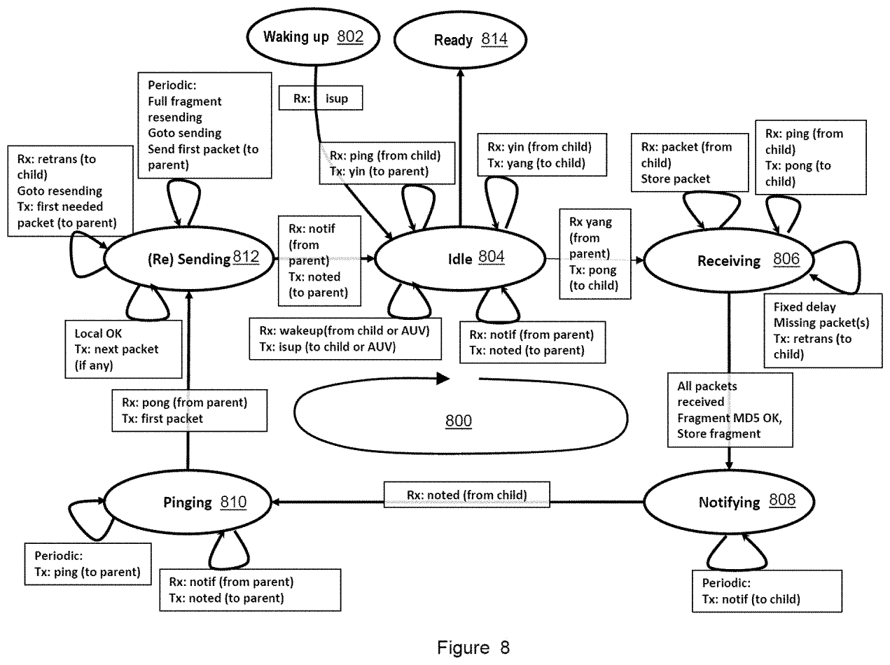

Returning to FIG. 5, for a node N_{A} at position n in a routing path, the method of the invention consists in probing the two nodes at linear positions n+1 and n+2, i.e. nodes N_{B} and N_{C}. The probing according to the invention consists in sending short probing signals, i.e. short relative to the duration of transmission of a data fragment, so as to ensure the availability of the next two nodes, parent and grandparent. Advantageously, the probing messages are short so as not to risk disturbing a data fragment communication in progress. Checking the availability of a node in the context of the invention is understood in terms of state machines: the node must be in the available, or ‘idle’, state as represented in FIG. 7 or FIG. 8.

FIG. 5 illustrates in the middle part the proposed two-hop probing sequence or probing mechanism: node N_{A} at position “n” (to the left in the figure) named child node which wishes to transmit a data fragment first transmits a short probing signal called a “ping” probing message intended for the next node N_{B} at position “n+1”, which is named parent node of the child node N_{A} at position n. If the parent node N_{B} is available in that it is in a wait state, it transmits upon its turn a short probing signal called a “yin” probing message to its own parent which is node N_{C} at position “n+2”. The node at position “n+2” is also the grandparent node of the child node at position “n”. If the grandparent node is available, it responds to the parent node N_{B} at position “n+1” with a response signal to the short probing called a “yang” response message. If the node at position “n+1” is still available, it sends to node N_{A} at position “n” a response signal to the short probing called “pong”. The reception of the “pong” probing response message authorises node N_{A} at position “n” to start the transmission of the current fragment to the node N_{B} at position “n+1”. Thus, the sequencing of a two-hop probing on a triad of nodes provides an optimum rate for the data fragments to be transmitted for a data block, and provides for optimising the transmission time.

When an initial child node has one or more fragments to transmit, it must thus probe its “parent” and “grandparent” nodes according to this two-hop probing mechanism, until a “pong” probing response message is obtained, before transmitting a fragment. As illustrated in the bottom part of FIG. 5, after reception of the pong message validating the possibility of transmission, the initial node N_{A} changes to a transmitting state “T_{X}”, node N_{B} changes to a receiving state “R_{X}”, and node N_{C} changes to a wait state “IDLE”.

If, during a probing action, one of the two nodes, parent or grandparent, is not available, the initial child node does not then receive the pong probing response message, and it regularly restarts a ping probing message to its parent node, which as soon it is available sends a yin probing message to the grandparent node. The transmission of a file fragment will take place only after the initial node has received a probing response message (the pong message).

FIG. 7 illustrates a message communication sequence for the transmission of fragments of files, implementing the two-hop probing principles of the invention according to one embodiment. The sequence, where in the figure time runs downwards, is described for the sending of data packets corresponding to file fragments on a routing path established between a source node and a destination node comprising at least one chain of nodes N_{A}, N_{B}, N_{C}, N_{D}. A routing path can be defined statically in order that each node of the network is preconfigured, having knowledge of neighbouring nodes forming the child, parent and grandparent nodes. The two-hop probing sequence is applied on all child/parent/grandparent triads forming a routing path between a source node transmitting data and a destination node receiving data.

Returning to FIG. 7, node N_{A} has at a given moment a data fragment to send. This fragment has been received by node N_{A} via the node which preceded it in the chain, not represented in the figure. This chain of nodes is thus assumed to form a part of a longer chain enabling communications for example between an autonomous underwater vehicle (AUV) and a moored ship corresponding to a gateway (GW), in one embodiment for an acoustic mesh network. A person skilled in the art understands that node N_{A} can correspond to the autonomous underwater vehicle or to an intermediate node in the routing path, the two-hop probing principle remaining the same. Similarly, node N_{D} can correspond either to an intermediate node or to the gateway node.

Child node N_{A} sends (702) to its parent neighbour in the chain of nodes, i.e. node N_{B}, “ping” probing messages. The structure of a ping probing short message is represented hereafter in an embodiment in which the name of the message is the content of the message in ASCII code:

“ping” message=>4 bytes, ASCII codes: ‘p’,‘i’,‘n’,‘g’

At MAC level, a “ping” probing message is addressed to the parent node of the child node initiating the ping probing message.

These messages are sent regularly, until a “pong” message is received. FIG. 7 shows a case in which the first two “ping” messages (illustrated by dotted lines) are not received by the parent node N_{B}, in order to illustrate that communication failures can exist. According to the example, the third “ping” message which is sent is positively received by the parent node N_{B}. Node N_{B} sends (704) upon its turn a “yin” probing message to its parent, node N_{C}, which is also the grandparent node of the initial node N_{A}. The structure of a yin short message is represented hereafter in an embodiment in which the name of the message is the content of the message in ASCII code:

“yin” message=>3 bytes, ASCII codes: ‘y’,‘i’,‘n’

At MAC level, a “yin” probing message is addressed to the parent node of the node initiating the yin message.

Upon receiving the yin message, node N_{C} sends (706) a “yang” short response message to node N_{B} which upon reception sends (708) a “pong” response message to node N_{A}.

The structure of the yang short message and the pong short message is represented hereafter in an embodiment in which the name of the message is the content of the message in ASCII code:

“yang” message=>4 bytes, ASCII codes: ‘y’,‘a’,‘n’,‘g’

“pong” message=>4 bytes, ASCII codes: ‘p’,‘o’,‘n’,‘g’

At MAC level, a “yang” probing response message is addressed to the parent node which sent the “yin” probing message, and a “pong” probing response message is addressed to the child node which sent the initial “ping” probing message.

For the sake of simplifying the description, the messages (yin, yang, pong) are considered as being sent and received without communication failure, although various communication failure scenarios can be considered on these messages, such as for example the loss of one or more “yin” or “yang” or “pong” messages. Advantageously, since the “ping” message is sent by the initial node N_{A} at regular intervals, the latter will receive at a given moment a response by a “pong” probing response message characterising the availability state of the next two nodes N_{B} and N_{C} in the routing path, and this despite one or more communication failures having been able to generate message losses (i.e. message transmissions which do not give rise to reception in the target receiving node).

Upon receiving the “pong” probing response message, node N_{A} starts the transmission (710) of a first data fragment intended for the next node N_{B}. In the example of FIG. 7, the transmission of a data fragment is subdivided into the successive sending of three packets illustrated by the dotted-line grouping of the three arrows. In one embodiment for an acoustic mesh network in which a node is formed by a modem and its controller, upon each transmission of a packet from the acoustic modem controller to its acoustic modem, the modem can respond by an “OK” signal indicating that the packet has definitely been placed in a queue and will be sent over the acoustic channel.

The general method of transmission can include a mechanism of selective retransmission. If at the end of an arbitrary delay, the receiving node has not received all of the packets expected, it sends to the transmitting node a request to retransmit the missing packets. This mechanism assumes packet header structures which inform the receiver of the index of the received packet in the fragment as well as about the index of the fragment for which this packet is issued.

In other embodiments, the data fragment is sent as a single data packet. The general method of transmission can include a mechanism for retransmitting the whole fragment. If at the end of a given delay the transmitter has not received a signal coming from the receiver notifying it of a positive reception (“notif” message), it retransmits the whole of the fragment, i.e. all the packets forming it with the assumption that the fragment is divided into a set of packets.

Once the data fragment is received by the next node N_{B}, the general method of transmission can perform a check on the integrity of the received fragment. This check assumes the existence of a control field included in the frame of the received fragment. This control field can be calculated by a hash algorithm, for example of the “MD5” type relating to the data contained in the fragment. In a well-known way, the receiver recalculates this hash and if the result matches the hash received, the received fragment can be declared correct.

Returning to FIG. 7, if and when the next node N_{B} has established the integrity of the received fragment, the latter notifies (712) the transmitting node N_{A} of the positive reception of the said fragment. To this end, it sends to the transmitting node N_{A} “notif” messages at regular intervals, until a “noted” message is received (714) from node N_{A} in return, informing it that it has definitely been notified.

FIG. 7 also illustrates the notion of the state associated with each node. At the start, the initial node N_{A} which has a data fragment to transmit is in a (pinging) state in which it sends (702) short probing signals, “ping”, to the next node N_{B} until the “pong” probing response signal is received (708) therefrom. Once the “pong” message is received, node N_{A} changes to a transmission state (T_{X}) in which it can transmit the fragment to node N_{B}. It remains in this state until the notification message is received from node N_{B}. Upon receiving this (Notif.) message, node N_{A} enters the (Idle) state awaiting reception of a new fragment.

At the same time when the transmitting node N_{A} changes to the (pinging) state, then (T_{X}), then (Idle), node N_{B} plays the role of receiver and notifier, and changes successively to the (Idle), (R_{X}) and (Notif.) states. More specifically, node N_{B} changes from the (Idle) state to the (R_{X}) state upon receiving (706) the “yang” probing response message from node N_{C}. Then, when it has received (710) the whole of the fragment and verified its integrity, it changes to the (Notif.) state. Lastly when it receives (714) the “noted” message from node N_{A}, it changes to the “pinging” state since it has just received (710) a fragment which it must upon its turn transmit to the next node N_{C}. It is to be noted that node N_{B} is hence in the state in which node N_{A} was at the start of the sequence. Node N_{B} then starts the transmission of the fragment to node N_{C} following the same sequence as that followed by node N_{A} previously with a two-hop probing (716, 718, 720, 722), the sending of the fragment (724) and the notification (726, 728). Node N_{B} transitions through the successive states of (Pinging), then (T_{X}), then (Idle). Node N_{C} plays the role of receiver and follows a sequence identical to that followed previously by node N_{B} when it is receiving from node N_{A}, transitioning through the successive states of (R_{X}), then (Notif.), then (Pinging).

In addition, the various states in which a node can be in are also illustrated in the state machine of FIG. 8.

In one embodiment for an acoustic modem mesh network, three different state machines can be implemented: one to control the modem on board the autonomous underwater vehicle, one to control each modem of the mesh network and one to control the modem associated with the gateway. FIG. 8 illustrates a simplified representation of a state machine (800) for a modem of the mesh network.

The wake-up management of a modem is not illustrated, and the first state (802) of a modem is represented by its “waking-up”. Since a modem is powered by battery, it is appropriate to limit its consumption as much as possible to maximise battery life before recharging. To this end, modems are able to “go to sleep” and to wake up on receiving acoustic signals. Once asleep, the modem consumes little from the battery. When a modem is in the waking-up state, the modem controller makes sure of the functionality of the modem by checking its response to simple commands. This state is introduced due to asynchronism between the modem controller and the associated modem. It is possible that upon waking up, the modem controller becomes operational before the modem; it is therefore appropriate that the controller “waits” by querying the acoustic modem, until the latter provides a characteristic response of its awakened and operational state. The controller then changes to a “Ready” state (814), in which it is ready. If the mesh controller changes to the “Ready” state, it has been awakened. It can have been awakened for various reasons. One of these reasons can be that it must contribute to the dissemination of a notification in the mesh network, which notification may be retrieved by the autonomous underwater vehicle (AUV) when it will attach (in terms of communication) to a node of the mesh network. If the node has been awakened to participate in the transmission of a report from the AUV to the gateway, it enters a state referred to as “waking_up” in which the first action to take in order to transmit a report from the AUV to the gateway consists in “waking up” all the modems which are on the path from the AUV to the gateway. Once all are awakened, these modems are supposed to keep the awakened state until they have processed all the fragments from the first fragment received to the last fragment of the report (or until an expiry time is reached). They can then go back to sleep. Once the AUV has attached to a node of the mesh network with the aim of transmitting a report, it requests the selected node to awaken its parent, which will in turn awaken its parent, etc, until the gateway node is reached.

If a node is awakened to transmit a report to the gateway, the first state in which it enters is a state in which it endeavours to awaken its parent node. This is the waking-up state (802). In this state, it sends an acoustic message called “wakeup” in broadcast mode until a confirmation of the waking-up is received from its parent, manifested by a message referred to as “isup”. Once the “isup” message is received from the parent, the modem controller enters an “idle” wait state (804).

It is to be noted that collisions are not excluded between the “wakeup” messages and the “isup” messages. To prevent systematic collision situations from enduring, the “wakeup” messages are not transmitted at regular intervals. For example, the period between two “wakeup” messages can be 2 or 3 seconds, the choice hence being made on a purely random criterion.

Once in the “idle” state, a mesh node is available to relay fragments to the parent node. The mesh nodes necessarily follow the following sequence of states:
Idle state (804)=>Rx state (806)=>Notif. state (808)=>Ping. state (810)=>Tx state (812)=>Idle state (804)

Thus, a mesh node waits for a next fragment in the “Idle” state (804), then receives it in the “R_{X}” state (806), then notifies the positive reception to the child node which transmitted this fragment to it in the “Notif.” state (808), then enters the “Ping.” state (810) for a two-hop probing in which it makes sure of the state of availability of its parent and of its grandparent, then enters the transmission or retransmission state “T_{X}” (812), then returns to the “Idle” state (804) in which it becomes available to receive a next fragment. When a current processed fragment is the last fragment of the report to be sent, the mesh node returns to the “Ready” state (814) while programming a rapid falling-asleep (so that it will not remain in the “Ready” state for a long time).

FIG. 8 shows that at each state, a node can receive (Rx) or transmit (Tx) parent/child notifications or messages, according to the position of the node and the progress of the sending of fragments in the path to the destination.

Similarly but not illustrated, the source (AUV) and destination (GW) nodes are managed by state machines. The general transmission method associated with the two-hop probing method advantageously provides for a solution to the technical problem of how to enable an autonomous underwater vehicle to transmit a measurement report to a gateway node via a mesh network of acoustic modems, in a minimum length of time, given the constraints of low rates on the acoustic links and with minimal consumption of modem batteries.

1. A method implemented by computer to transmit data blocks formed by several data fragments, in a wireless network comprising a plurality of nodes, the network having at least one routing path defined between a source node and a destination node and composed of a plurality of nodes such that three nodes at positions n/n+1/n+2 on the routing path define a child/parent/grandparent triad, the method comprising at least the following steps performed on a triad of child, parent and grandparent nodes:
sending from a child node a child/parent probing message, referred to as a “ping” message, to a parent node;
sending from the parent node having received the “ping” message a parent/grandparent probing message, referred to as a “yin” message, to a grandparent node, if the parent node is available in a wait state;
sending from the said grandparent node having received the “yin” message a parent/grandparent probing response message, referred to as a “yang” message, to the said parent node, if the grandparent node is available;
sending from the said parent node having received the “yang” message a child/parent probing response message, referred to as a “pong” message, to the said child node, if the parent node is still available; and
upon reception of the “pong” message by the child node, transmitting a data fragment from the child node to the said parent node.

2. The method according to claim 1, wherein the steps are repeated for several triads of child/parent/grandparent nodes, on the routing path from the data transmitting source node up to the recipient node for the data.

3. The method according to either claim 1, wherein the triads of child/parent/grandparent nodes are predefined.

4. The method as claimed in claim 1, wherein the data transmission step consists in successively transmitting data packets.

5. The method according to claim 1, additionally comprising a step for verifying the integrity of the data received.

6. The method as claimed in claim 1, wherein the “ping”, “yin” probing messages and the “yang”, “pong” probing response messages are short messages encoded in ASCII.

7. A device for transmitting data blocks formed by several data fragments, in a wireless network comprising a plurality of nodes, the network having at least one routing path defined between a source node and a destination node and being composed of a plurality of nodes such that three nodes at positions n/n+1/n+2 on the routing path define a child/parent/grandparent triad, the device comprising means for implementing the steps of the method according to claim 1.

8. The device according to claim 7, wherein the wireless network is a mesh network.

9. The device according to claim 8, wherein the mesh network is a mesh network comprising a plurality of acoustic modems.

10. The device according to claim 9, wherein one modem is a source node corresponding to an autonomous underwater vehicle and one modem is a gateway node to a ship, the device enabling the transmission of data relating to measurement reports, from the autonomous underwater vehicle to the ship.

11. The device according to claim 10, wherein each modem is coupled respectively to a modem controller, in particular via an RS232 serial link.

12. The device as claimed in claim 7, wherein the means for carrying out the steps of the method are a state machine.

13. A computer program product, the said computer program comprising non-transient code instructions for carrying out the steps of the method according to claim 1, when the said program is executed on a computer.
